(19) United States
(12) Patent Application Publication
(10) Pub. No.: US 2015/0154798 A1
(43) Pub. Date: Jun. 4, 2015

(54) Visual Transitions for Photo Tours Between Imagery in a 3D Space

(71) Applicants: Matthew Robert SIMPSON, San Francisco, CA (US); Jonah Jones, Darlinghurst (AU); Yasutaka Furukawa, Bellevue, WA (US); Steven Maxwell Seitz, Seattle, WA (US); Andrew Ofstad, San Francisco, CA (US)

(72) Inventors: Matthew Robert SIMPSON, San Francisco, CA (US); Jonah Jones, Darlinghurst (AU); Yasutaka Furukawa, Bellevue, WA (US); Steven Maxwell Seitz, Seattle, WA (US); Andrew Ofstad, San Francisco, CA (US)

(73) Assignee: Google Inc., Mountain View, CA (US)

(21) Appl. No.: 13/458,631

(22) Filed: Apr. 27, 2012

Related U.S. Application Data
(60) Provisional application No. 61/582,150, filed on Dec. 30, 2011.

(51) Int. Cl. G06T 19/00; G06T 17/00

(52) U.S. Cl. CPC G06T 19/003; G06T 2207/10028

(57) ABSTRACT

A computer-implemented method, system and computer-readable medium for transitioning between images in a three-dimensional space are provided. A three-dimensional (3D) model of a location that includes multiple two-dimensional images textured onto the 3D model and each image is associated with a set of credentials is provided. A virtual path is generated within the 3D model, the virtual path including at least some of the plurality of images in the sequential order. For each image in the virtual path, a type of a transition within each image and between the adjacent images in the sequential order is determined. The type of transition is based on the set of credentials associated with each image. As the virtual path is traversed using a virtual camera, where the virtual camera activates transitions associated with each image and the transitions ensure that the movement within the 3D model appears constant to the user.

This application claims the benefit of U.S. Provisional Application No. 61/582,150, filed on Dec. 30, 2011 and is incorporated by reference in its entirety.

### BACKGROUND

Panning and zooming effects are used on a photograph or another type of a two-dimensional representation of still imagery. For example, a camera may zoom in on an object in a single photograph and pan to other objects within the same photograph. This provides an illusion that an object in a photograph is moving, as in a video.

Objects in a two-dimensional image may be modeled using a three-dimensional model that is displayed by a computing device. One way to model an object in a three-dimensional space, is to position multiple two-dimensional images of an object that are taken from different angles, onto a three-dimensional model of the object. When two-dimensional images are positioned in a three-dimensional space, credentials are associated with each image. Example credentials may include a position of an image in the three dimensional space, depth map of the image, and the position and orientation of a camera that has taken the image.

In addition, what is needed are a system or method for adding zooming and panning effects to a three-dimensional model composed of multiple images such that the transition from one image to another is seamless to a user viewing the model by a computing device.

### BRIEF SUMMARY

A computer-implemented method, system and computer-readable medium for transitioning between images in a three-dimensional space are provided. A three-dimensional (3D) model of a location is provided where the 3D model includes multiple two-dimensional images textured onto the 3D model and each image is associated with a set of credentials. A virtual path is generated within the 3D model, the virtual path including at least some of the plurality of images in the sequential order. For each image in the virtual path, a type of a transition within each image and between the adjacent images in the sequential order is determined. The type of transition is based on the set of credentials associated with each image. As the virtual path is traversed using a virtual camera, where the virtual camera activates transitions associated with each image and the transitions ensure that the movement within the 3D model appears constant to the user.

Further embodiments, features, and advantages of the invention, as well as the structure and operation of the various embodiments of the invention are described in detail below with reference to the accompanying drawings.

### BRIEF DESCRIPTION OF THE DRAWINGS/FIGURES

The accompanying drawings, which are incorporated herein and form a part of the specification, illustrate embodiments of the invention and, together with the description, further serve to explain the principles of the invention and to enable a person skilled in the relevant art to make and use the invention.

FIG. 1 is a block diagram of an image display environment, where the embodiments of the invention can be implemented.

FIG. 2 is a block diagram of a geographic model displayer, according to an embodiment.

FIG. 3 is a flowchart for making transitions between two-dimensional images within a three-dimensional model, according to an embodiment.

FIG. 4 is a block diagram of a computer system in which embodiments of the invention can be implemented.

The invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION OF EMBODIMENTS

The following detailed description refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

### Example System Embodiments

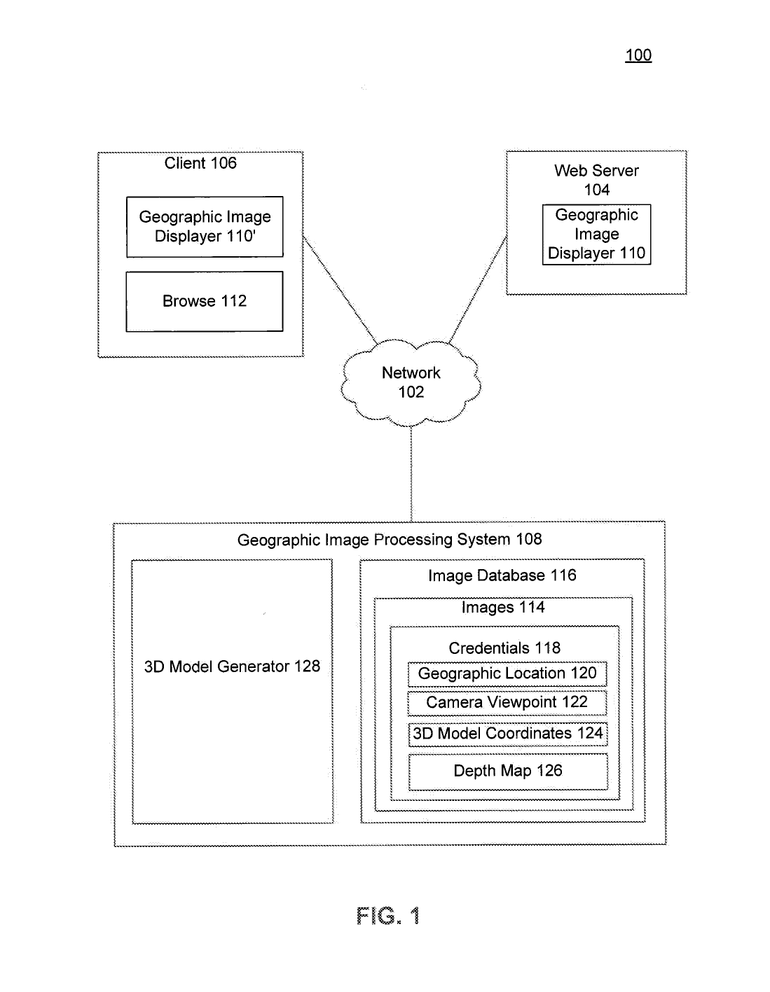

FIG. 1 is a block diagram of an exemplary image display environment 100. Image display environment 100 includes a network 102, a web server 104, a client 106, and geographic image processing systems (GIPS) 108.

Network 102 may be any network or combination of networks that can carry data communication. Network 102 may include, but is not limited to, a local area network, metropolitan area network, and/or wide area network such as the Internet. Network 102 can support technologies including, but not limited to, the World Wide Web (“the Web”) that provide access to services and applications using protocols, such as a HyperText Transfer Protocol (“HTTP”). Intermediate web servers, gateways, or other servers may be provided between components of the system shown in FIG. 1, depending upon a particular application or environment.

Web server 104 is a computing device that hosts multiple resources. Web server 104 transmits those resources to client 106, where client 106 may include one or more clients. Web server 104 may also retrieve resources from other computing devices and provide resources to client 106. Example resources may include any data that can be provided over network 102. A resource is identified by a resource address that is associated with the resource. Resources include web pages, such as HyperText Markup Language (HTML) pages, scripts, word processing documents, portable document format (PDF) documents, images, and video, to name only a few. Resources can also include content, such as words, phrases, images and sounds, that may include embedded information (such as meta-information in hyperlinks) and/or embedded instructions (such as JavaScript scripts).

In addition to resources, web server 104 may store a geographic image displayer (GID) 110. GID 110 may be a standalone application or a plug-in for a browser executing on client 106 and is described in detail below.

Client 106 is an electronic device that is manipulated by a user and is capable of requesting and receiving resources over network 102. For example, client 106 can include personal computers, laptop computers, smartphones, and tablet computers, to name only a few. Client 106 typically includes an application, such as a web browser (or simply “browser”) 112. Browser 112 is used to request resources over network 102. For example, a user requests a resource by typing, selecting or entering an identifier (such as a URL) of a resource stored on web server 104. In response to a request, web server 104 transmits a resource to client 106.

As part of the request for resources, client 106 may request GID 110 from web server 104 for installation as a standalone application or a plug-in for browser 112 on client 106. To download GID 110, client 106 uses a web address to connect to web server 104 that previously stored GID 110. Once downloaded and installed on client 106, GID 110 is designated as GID 110′ in FIG. 1.

GID 110 enables a user using client 106 to view 3D models of real-world locations, e.g., from places around the world. GID 110 allows a user to select a particular location by, for example, entering the name of the location, geographic coordinates of the location (such as latitudinal and longitudinal coordinates), etc. In response to the selection, OLD 110 retrieves and displays a three-dimensional (3D) model associated with the selected location that includes multiple two-dimensional images, such as photographs, that are textured on the 3D model in the 3D space. Example models may include famous landmarks, buildings, city squares, statutes, interior and exterior of buildings, city blocks, etc. Additionally, the functionality of GID 110 may be extended to display images of any other locations, such as solar systems, stars, moons, galaxies, oceans, shipwrecks, etc.

To obtain a 3D model of a real-world location, GID 110 communicates with GIPS 108 using, for example, network 102. GIPS 108 is a system for archiving, retrieving, displaying or manipulating images 114. Images 114 may be two-dimensional images of different locations throughout the world. Example images 114 may be photographs of real-world locations. Images 114 may be submitted by users using client 106 or taken using a satellite, an air based vehicle, or a ground based vehicle with an image capture device. Images 114 may be photographic images that include, but are not limited to, portions of panoramic images, such as street-level panoramas or satellite images. Images 114 may also be images that were processed, cropped, and/or combined by various methods known to a person skilled in the relevant art by GIPS 108 or another image processing system.

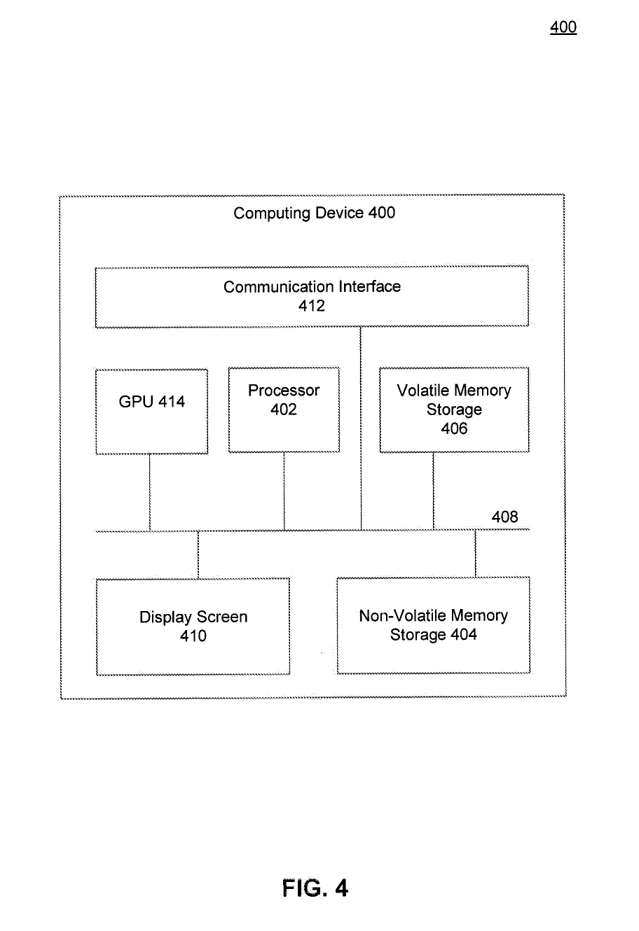

Images 114 are stored in image database 116. Image database 116 may be a memory storage (described in detail in FIG. 4). Image database 116 may be included within GIPS 108 or be communicatively coupled to GIPS 108 via network 102 (not shown).

Images 114 include multiple credentials 118. Credentials 118 describe information associated with each image of image 114. Example credentials 118 may include geographic location 120, camera viewpoint 122, or 3D model coordinates 124. Geographic location 120 includes real-world coordinates, such as latitudinal and longitudinal coordinates of each image 114, a name of a real-world location or landmark, or another designation for a geographic location 120 as determined by GIPS 108 developer.

A model generator 128 generates three-dimensional (3D) models from images 114. Model generator 128 may be located within GIPS 108, in an embodiment. In another embodiment, model generator 128 may also be located within GID 110 (not shown) and upload images 114 to GID 110 before generating 3D models. A 3D model is a three-dimensional representation of a surface of a two-dimensional object (such as an object included in image 114). Every point in a 3D model may be described in an “x,” “y,” and “z” coordinate system, or another coordinate system known to a person skilled in the relevant art. Those 3D points are connected using triangles, lines, curved surfaces, etc. that form three-dimensional representations of objects.

As model generator 128 generates a 3D model from images 114, model generator 128 also generates other credentials 118 for each image 114 that are associated with the 3D model. Example credentials 118 that are associated with the 3D model include a camera viewpoint 122, 3D model coordinates 124, and a depth map 126.

To generate a 3D model from images 114, model generator 128 analyzes multiple images having the same or similar geographic location 120. Model generator 128 may select, for example, images 114 having the same or similar geographic coordinates, name of the location, etc. By analyzing multiple images 114, model generator 128 may determine a 3D point having the same coordinates in multiple images. The 3D point corresponds to a particular location of image 113 within the 3D model. Based on the 3D point, model generator 202 may estimate the camera viewpoint 122 of each of image 114 that includes the 3D point. Camera viewpoint 122 describes the location and orientation of a camera that has taken the respective image 114. Based on camera viewpoint 122, model generator 128 assigns 3D model coordinates 124 to a particular image of images 114 within the 3D model. 3D model coordinates determine the placement of image 114 within the 3D model. Once multiple images of images 114 of a particular area are processed, model generator 128 is able to generate a 3D model of objects in a particular geographic location that is textured with the two-dimensional images 114.

For example, model generator 128 may generate a 3D model of an Eiffel Tower. To generate the 3D model, model generator 128 processes multiple images 114, such as photographs of an Eiffel Tower submitted by multiple users. The images generate a 3D model that allows the viewing of the Eiffel Tower from multiple sides, from outside of the Eiffel Tower, and from the inside of the Eiffel Tower, to give a few examples. Each image of the Eiffel Tower that is included in the 3D model includes 3D model coordinates 124 that define the position of the respective image within the 3D model.

The description above for generating a 3D model from multiple images 114 is generally known to a person skilled in the art and is outside of the scope of this patent application. Other methods for generating a 3D model from images 114 may be used as well.

Credentials 118 may also include a depth map 126. Depth map 126 includes information relating to a distance of objects in images 114 from camera viewpoint 122. In an embodiment, depth map 126 may include a depth coordinate, such as a “z” coordinate, which specifies the depth of objects in images 114 with respect to each other. Depth map 126 may be applied to one or more 3D models that may include images 114. Different methods for generating a depth map 126 for images 114 are known to a person skilled in the relevant art and are outside of the scope of this patent application. When model generator 128 constructs a 3D model of a location, model generator 128 may use depth map 126 of each image of images 114 included in the 3D model to determine the relationship of each image of images 114 to one another.

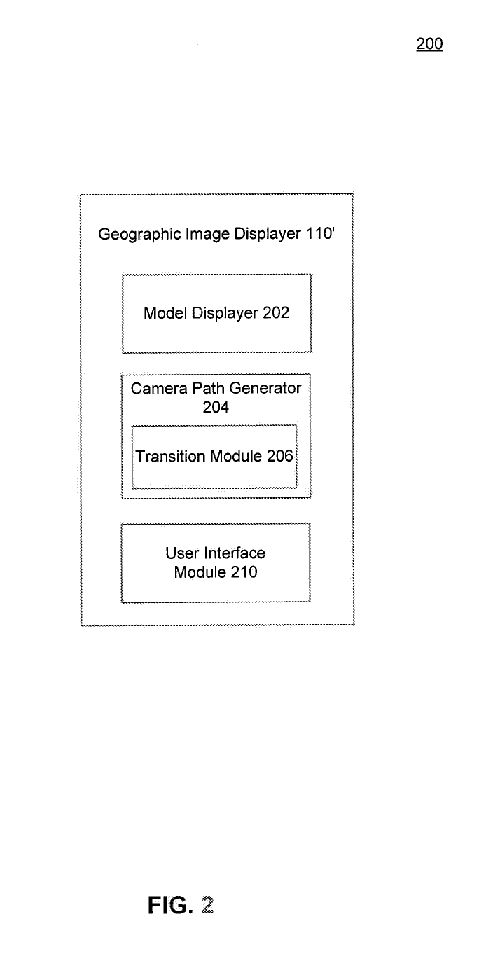

FIG. 2 is a block diagram 200 of a geographic image displayer (GID), according to an embodiment. As described herein, GID 110 may be downloaded onto client 106 as a plug-in for browser 112 (not shown) or as a standalone application, such as GID 110′. GID 110′ enables a user to view 3D models of geographic locations having multiple two-dimensional images 114 textured onto the 3D model. Images 114 are positioned within the 3D model such that the 3D model emulates objects in the actual real-world.

To select a particular location for which model generator 128 generates a 3D model, client 106 may include user interface module 210. User interface module 210 receives user input and propagates the received input to components within client 106, such as GID 110′. In some embodiments, user interface module 210 may also be included in GID 110′ (not shown).

User interface module 210 receives a user selection of a desired location. For example, a user may enter a name of a location or the geographic coordinates of the location. In another example, user interface module 210 may receive a selection when a user selects, via a pointing device, a desired location in the sphere that represents Earth, and clicks or otherwise selects the location. The selection may be fine-tuned when user interface module 210 receives instructions to “zoom in” or increase the granularity of a particular location, prior to the selection. User interface module 210 may also receive instructions from a user using a touch-screen display, a keyboard, a voice recognition application, etc.

Once user interface module 210 receives a selection, user interface module 210 transmits the selection to GID 110′. GID 110′ converts the selection into a geographic coordinate format. The geographic coordinate format is recognizable to GIPS 108, and may be the same format as geographic location 120 in images 114. Once GID 110′ identifies the selected geographic coordinates, GID 110′ transmits a request message to GIPS 108. The request message includes the geographic coordinates identified by GID 110′.

In response to the request, message GIPS 108 transmits a 3D model that corresponds to the geographic coordinates in the request message. In one embodiment, 3D models may be pre-generated by 3D model generator 128 and stored within GIPS 108 (not shown). In another embodiment, in response to receiving geographic coordinates in the request message, GIPS 108 retrieves images 114 from image database 116 and causes 3D model generator 128 to generate the 3D model.

Once the 3D model is generated or retrieved, GIPS 108 generates a response message to GID 110′. The response message includes the 3D model, images 114 that are included in the 3D model, and credentials 118 associated with each particular image in images 114. On& generated, GIPS 108 transmits the response message to GID 110′ on client 106.

GID 110′ includes a model displayer 202 and a camera path generator 204. In an embodiment, camera path generator 204 may also be a component of web server 104 or geographic image processing system 108 (not shown) that communicates with GID 110′ or GID 110. When client 106 receives the response message and passes the response message to GID 110′, model displayer 202. displays the 3D model included in the response message to a display screen of client 106.

Model displayer 202 enhances the viewing experience of a user by presenting the user with a dynamic viewing that allows a user to view multiple Objects in images 114 from multiple locations within the 3D model. When a user views a 3D model in a dynamic viewing, the user is moving through the 3D space composed of multiple images of images 114. In one embodiment the movement within the 3D model is constant to the user. In a constant movement, the 3D model appears to be constantly moving, such that model displayer 202 does not present a user with a static image or stops the movement within 3D model when transitioning between images 114 that are included in the 3D model.

The motion is analogous to a “Ken Burns” effect in cinematography, but is extended to a single image 114 or multiple images 114 that are included in a three-dimensional space. A person skilled in the art will appreciate that the Ken Burns effect allows an action to be given to a still, two-dimensional photograph by slowly zooming in on the object of interest in the photograph, and then panning from one object of interest to another. For example, in a conventional two-dimensional image of an Eiffel Tower, a Ken Burns effect may be achieved by zooming in at the area of the photograph that shows a top of the Eiffel Tower, and slowly panning along the edge of the Eiffel to one of its four bases. The conventional “Ken Burns” effect, however, is able to zoom and pan on objects within a single two-dimensional photograph or image.

Unlike a conventional two-dimensional “Ken Burns” movement within a photograph, the 3D model provides a user with an environment that allows a user to view objects in single image 114 or multiple images 114 that comprise the 3D model, “Ken Burns” style.

The 3D model that includes images 114 provides a user with a context of the real-world environment. For example, the 3D model allows a user to understand how one image in images 114 relates to another image in images 114 that is adjacently located. For example, when a user views a 3D model of a Statue of Liberty, model displayer 202 may display the complete model of the Statue of Liberty, then zoom in to the left side of the face of the Statue of Liberty, such that only the left side of the face is displayed by model displayer 202 on client 106. Model displayer 202 may then move and rotate within the 3D model, in what a user may perceive as a semi circle, to the front of the face of the Statue of Liberty, and then to the right side of the face of the Statue of Liberty.

When moving within left, front or right sides of an object in the 3D model, such as the Statue of Liberty, model displayer 202 may move within a single image of images 114 that is textured onto the 3D model of the Statute of Liberty. However, to display all sides of an object, such as all sides of the face of the Statue of Liberty, model displayer 202 may display multiple images 114 textured onto the 3D model of the Statute of Liberty.

To view the 3D model, a virtual path within the 3D model is created. For example, GIP 110′ includes a camera path generator 204 that generates a virtual path. The virtual path includes images of images 114 included in the 3D model, that are displayed in sequential order. Camera path generator 204 uses credentials 118 of images 114 included in the 3D model to generate the virtual path.

The virtual path is traversed by a virtual camera that displays the 3D model from multiple sides and angles. For example, as the virtual camera travels the virtual path, model displayer 202 displays a single or multiple 114 that are included in the virtual path on a display screen of client 106. The effect is that model displayer 202 provides a user with a view of the 3D model as the virtual camera travels around the virtual path.

Camera path generator 204 may also determine the position or orientation of the virtual camera as it travels along the virtual path based on the credentials 118 of each image.

To transition between multiple images 114 included in the virtual path, camera path generator 204 includes a transition module 206. In an embodiment, transition module 206 may be a component of web server 104 or geographic image processing system 108 (not shown) that communicates with GID 110′ or GID 110. Transition module 206 ensures that the transitions within image 114 and between images 114 that occur as virtual camera travels the virtual path are seamless to the user. For example, transition module 206 ensures that the virtual camera maintains a dynamic and constant movement within the 3D model as it travels the virtual path within image and between adjacent images of images 114 included in the virtual path. In other words, transition module 206 determines the type of transition such that a static 3D model (a 3D model that is not constantly moving) is not visible to the user. To achieve seamless transitions, transition module 206 determines a type of a transition that is best suited for transitioning from one image of images 114 to an adjacent image of images 114 or within image 114. A person skilled in the art will appreciate that an adjacent images of images 114 in the virtual path may not necessarily be images that are adjacent to each other in the 3D model, but rather may be images of images 114 that are in a sequential order of images included in the virtual path.

Transition module 206 determines the type of a transition based on credentials 118 of images 114. The type of transition is based, for example, on camera viewpoint 122 and depth map 126 associated with image 114 included in the virtual path, and, in some embodiments, an adjacent image 114.

One type of transition is a movement across one or multiple images of images 114 in a particular direction. in this type of a transition, the virtual path does not change direction as it moves from one image of images 114 to an adjacent image of images 114. In an embodiment, transition module 206 may determine that the virtual path may not change direction when a transition is between multiple images of images 114 that have the same or similar camera viewpoint 122 from an object viewed in images 114. The same or similar camera viewpoint 122 may be defined as having a difference between particular coordinates that are included in camera viewpoints 122 of images 114 as being below a predefined threshold. In another embodiment, transition module 206 may determine that the virtual path may continue in the same direction when the difference in depth maps 126 associated with one image of images 114 and the adjacent image of images 114 is below a predefined threshold.

In another embodiment, when an angle of camera viewpoint 122 has changed from the one image of images 114 to the adjacent image of images 114, transition module 206 may not change the direction of motion, yet change the orientation of virtual camera in accordance with the direction of camera viewpoint 122 associated with the adjacent image of images 114.

In another embodiment, transition module 206 may elect to continue the motion in the same direction when a transition is from one image of images 114 having a smaller view port to an adjacent image of images 114 having a larger view port.

When transition module 206 determines to maintain the direction of the virtual path within image 114 or between one image and an adjacent image of image 114, GID 110′ provides a user with a “Ken Burns” style effect for viewing objects within image(s) 114 in the 3D space.

The purpose of generating transitions using transition module 206 that maintain the direction and momentum of the virtual camera during the transitions between images 114 is to allow camera path generator 206 to generate as much of a seamless motion as possible within the 3D model. The seamless motion, may prevent jarring transitions between images of images 114 that are included in the virtual path as the virtual camera displays random sections of the 3D model included in the virtual path.

In another embodiment, transition module 206 may select a zooming transition between images of images 114 included in the virtual path. Transition module 206 may select a zooming transition when relevant portions of depth map 126 of neighboring images 114 are different by a predefined threshold. The zooming transition may be a transition that zooms in or out between adjacent images of images 114.

In another embodiment, transition module 206 may select a cropping transition. A cropping transition may be selected within an image of images 114 to avoid exposing the edges of an image of images 114 in the 3D model when a virtual path reaches an edge of the 3D model. The cropping transition provides an illusion that a user is immersed within the 3D model as the virtual camera does not display the edge of the image of images 114 to the user, but changes to a different image of images 114, that may display another object in the 3D model.

In another embodiment, transition module 206 may use fading as a form of transition. For example, when depth map 126 or camera viewpoint 122 between the respective images of images 114 is different, transition module 206 may cause the virtual camera to fade out of an image of images 114 that it currently displays on the display screen, and fade into another image of images 114. The image of images 114, where the virtual camera fades into, may be a adjacent image of images 114 in the virtual path or an image of images 114 that is in a different section of the 3D model.

A person skilled in the art will appreciate that the transition types between multiple images 114 above where given by way of example and not limitation, and that other transition types based on camera viewpoint 122, 3D model coordinates 124 and depth map 126 may be selected as the virtual camera moves among images 114 within the 3D model.

### Example Method Embodiments

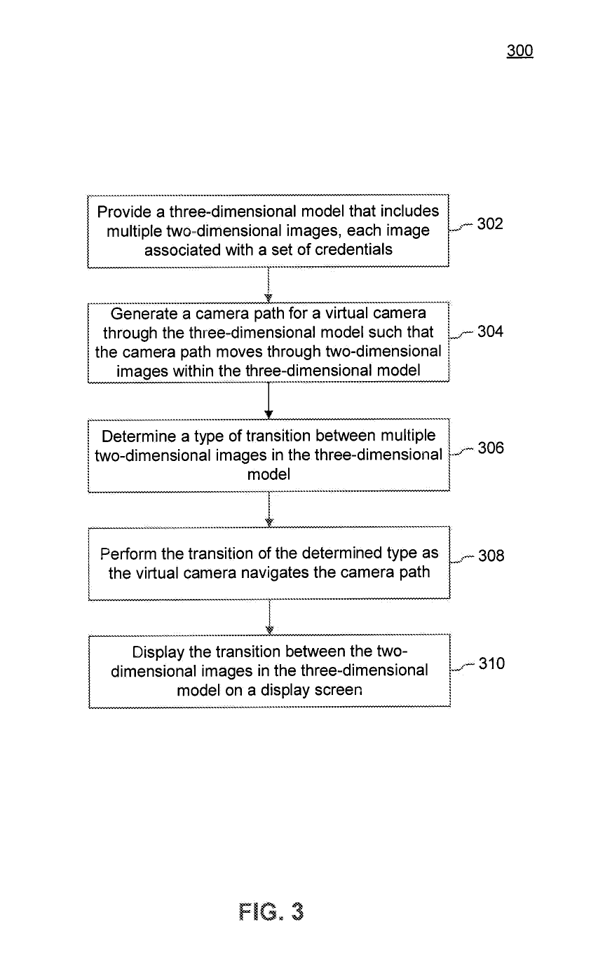

FIG. 3 is a flowchart of a method 300 for dynamically transitioning between multiple images within a 3D model, according to an embodiment.

At stage 302, a 3D model is provided. For example, a 3D model is provided to GID 110′. As described herein, the 3D model includes multiple images 114 of a particular geographic location, and may be provided in response to a request for viewing a particular geographic location.

At stage 304, a virtual path through the 3D model is generated. For example, camera path generator 204 creates a virtual path through the 3D model for a virtual camera. The virtual path includes images of images 114 that provide a tour of the 3D model. When the virtual camera traverses images of images 114 in the virtual path, the images are traversed in a particular order, such that the movement within the 3D model appears constant to the user. The constant movement allows model displayer 202 to display the 3D model which appears to be in a constant motion and does not appear to be static, to the user.

At stage 306, a type of transition is determined. For example, transition module 206 determines a type of a transition within image and adjacent images of images 114 that are included in the virtual path. This stage may be separate or part of stage 304 above. The type of transition within each image or between adjacent images of images 114 may be determined based on credentials 118 of an image of images 114 that is included in the virtual path. Credentials 118, such as camera viewpoint 122, 3D model coordinates 124 and depth map 126, may be used. For example, a transition may be to continue the direction of a virtual path within or between adjacent images 114 “Ken Burns” style. As described herein, this type of a transition may occur when variations in depth maps 126 associated with image and adjacent images of images 114 are below a predefined threshold. In another example, a zooming transition may occur when variations in depth maps 126 associated with adjacent images 114 are above a predefined threshold. In another example, a cropping or fading transition may occur when a virtual path is through an image of images 114 that is at the edge of the 3D model.

At stage 308, the transitions are performed. For example, as the virtual camera navigates the virtual path generated in stage 304, it performs the transitions within and between images 114 as determined by transition types in stage 306.

At stage 310, the effects of the transition are displayed on a display screen. For example, model displayer 202 displays each transition within an image and between adjacent images of images 114 to a user as the virtual camera traverses the virtual path within the 3D model.

### Example Computer System

FIG. 4 is an example computer system 400 in which embodiments of the present invention, or portions thereof, may be implemented as computer-readable code. For example, the components or modules of environment 100, such as graphic image processing system 108, geographic image displayer 110 and 110′, browser 112 and 3D model generator 128, etc., may be implemented in one or more computer systems 400 using hardware, software, firmware, tangible computer-readable media having instructions stored thereon, or a combination thereof and may be implemented in one or more computer systems or other processing systems. Modules and components in FIGS. 1-3 may be embodied in hardware, software, or any combination thereof.

Client 106, web server 104, and other devices in image processing and display environment 100 may include one or more computing devices. Those computing devices may include one or more processors 402, one or more non-volatile storage mediums 404, one or more memory devices 406, a communication infrastructure 408, a display screen 410 and a communication interface 412.

Processors 402 may include any conventional or special purpose processor, including, but not limited to, digital signal processor (DSP), field programmable gate array (FPGA), and application specific integrated circuit (ASIC).

GPU 414 is a specialized processor that executes instructions and programs, selected for complex graphics and mathematical operations, in parallel.

Non-volatile storage 404 may include one or more of a hard disk drive, flash memory, and like devices that may store computer program instructions and data on computer-readable media. One or more of non-volatile storage device 404 may be a removable storage device.

Memory devices 406 may include one or more volatile memory devices such as but not limited to, random access memory. Communication infrastructure 408 may include one or more device interconnection buses such as Ethernet, Peripheral Component Interconnect (PCI), and the like.

Typically, computer instructions are executed using one or more processors 402 and one or more GPUs 414. Computer instructions can be stored in non-volatile storage medium 404 or memory devices 406. Computer instructions may be stored on a computing device in a compiled file, an executable file or dynamically linked libraries or objects. Computer instructions may also be compiled on a computing device prior to execution or interpreted on the computing device. In a non-limiting example, computer instructions may be included in a routine, a subroutine, or layers of a software stack that are manipulated by processors 402 or GPUs 414.

Display screen 410 allows results of the computer operations to be displayed to a user or an application developer.

Communication interface 412 allows software and data to be transferred between computer system 400 and external devices. Communication interface 412 may include a modem, a network interface (such as an Ethernet card), a communications port, a PCMCIA slot and card, or the like. Software and data transferred via communication interface 412 may be in the form of signals, which may be electronic, electromagnetic, optical, or other signals capable of being received by communication interface 412. These signals may be provided to communication interface 412 via a communications path. The communications path carries signals and may be implemented using wire or cable, fiber optics, a phone line, a cellular phone link, an RF link or other communications channels.

Embodiments also may be directed to computer program products comprising software stored on any computer-useable medium. Such software, when executed in one or more data processing device, causes a data processing device(s) to operate as described herein. Embodiments of the invention employ any computer-useable or readable medium. Examples of computer-useable mediums include, but are not limited to, primary storage devices (e.g., any type of random access memory) and secondary storage devices (e.g., hard drives, floppy disks, CD ROMS, ZIP disks, tapes, magnetic storage devices, and optical storage devices, MEMS, nanotechnological storage device, etc.).

### Conclusion

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The Summary and Abstract sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

What is claimed is:

1. A computer-implemented method for transitioning between images in a three-dimensional space, comprising:
providing a three-dimensional (3D) model of a location, the 3D model including a plurality of images textured onto the 3D model, each image associated with a set of credentials;
generating a virtual path within the 3D model for viewing the 3D model, the virtual path including at least some of the plurality of images in a sequential order;
for each image included in the virtual path, determining a type of a transition within each image and between adjacent images in the sequential order, wherein the type of transition is based on the set of credentials associated with each image; and
traversing the generated virtual path using a virtual camera, wherein the virtual camera activates transitions associated with each image included in the virtual path as the virtual camera navigates through each image, wherein the transitions ensure that the movement within the 3D model appears constant to the user.

2. The computer-implemented method of claim 1, further comprising:
displaying the content of each image included in the virtual path as the virtual camera navigates the virtual path such that the 3D model appears to be in constant motion on a display screen.

3. The computer-implemented method of claim 1, wherein the location is a real-world location.

4. The computer-implemented method of claim 1, wherein the set of credentials associated with each image includes at least one of a 3D model coordinates of a location of each image within the 3D model, a depth map of each image and a camera viewpoint of each image.

5. The computer-implemented method of claim 4, further comprising:
based on the set of credentials, determining the type of the transition as maintaining the direction of the motion within each image and between the adjacent images in the virtual path through the 3D model.

6. The computer-implemented method of claim 4, further comprising:
based on the set of credentials, determining the type of the transition as a zooming motion within each image and between the adjacent images in the virtual path through the 3D model.

7. The computer-implemented method of claim 4, further comprising:
based on the set of credentials, determining the type of the transition as a cropping motion within each image and between the adjacent images in the virtual path through the 3D model.

8. The computer-implemented method of claim 4, further comprising:
based on the set of credentials, determining the type of the transition as a fading motion within each image and between the adjacent images in the virtual path through the 3D model.

9. The computer-implemented method of claim 4, further comprising:
based on the set of credentials, determining the type of the transition as changing the viewpoint of the virtual camera within each image and between the adjacent images in the virtual path through the 3D model.

10. The computer-implemented method of claim 4, further comprising:
based on the set of credentials, determining the type of transition as a “Ken Burns” transition within each image and between the adjacent images in the virtual path through the 3D model.

11. A system for transitioning between images in a three-dimensional space, comprising:
a geographic image displayer configured to:
request a three-dimensional (3D) model of a location, the 3D model including a plurality of images textured onto the 3D model, each image associated with a set of credentials, and a virtual path generated for viewing the 3D model wherein the virtual path passes through at least some of the plurality of images in a sequential order, and wherein for each image in the virtual path, a type of a transition is determined within each image and between adjacent images in the sequential order, wherein the type of transition is based on the set of credentials associated with each image; and
a model displayer configured to:
traverse the generated virtual path using a virtual camera, wherein the virtual camera activates transitions associated with each image included in the virtual path as the virtual camera navigates through each image, wherein the transitions ensure that the movement within the 3D model appears constant to the user.

12. The system of claim 11, wherein the model displayer is further configured to:
display the content of each image included in the virtual path as the virtual camera navigates the virtual path such that the 3D model appears to be in constant motion on a display screen.

13. The system of claim 11, wherein the location is a real-world location.

14. The system of claim 13, wherein the type of the transition as maintaining the direction of the motion within each image and between the adjacent images in the virtual path through the 3D model.

15. The system of claim 14, wherein the type of the transition as a zooming motion within each image and between the adjacent images in the virtual path through the 3D model.

16. The system of claim 14, wherein the type of the transition as a cropping motion within each image and between the adjacent images in the virtual path through the 3D model.

17. The system of claim 14, wherein the type of the transition as a fading motion within each image and between the adjacent images in the virtual path through the 3D model.

18. The system of claim 14, wherein the type of the transition as changing the viewpoint of the virtual camera within each image and between the adjacent images in the virtual path through the 3D model.

19. The system of claim 14, wherein the transition module is further configured to:
based on the set of credentials, determining the type of transition as a “Ken Burns” transition within each image and between the adjacent images in the virtual path through the 3D model.

20. A system for transitioning between images in a three-dimensional space, comprising:
a geographic image processing system configured to provide a three-dimensional (3D) model of a location in response to a client device request, wherein the 3D model includes a plurality of images textured onto the 3D model, each image associated with a set of credentials;
a camera path generator configured to generate a virtual path within the 3D model for viewing the 3D model, the virtual path including at least some of the plurality of images in a sequential order;
a transition generator configured to:
for each image included in the virtual path, determine a type of a transition within each image and between adjacent images in the sequential order, wherein the type of transition is based on the set of credentials associated with each image, and
wherein on the client device the presentation of the 3D model includes a virtual camera traversing the generated virtual path and activating transitions associated with each image included in the virtual path as the virtual camera navigates through each image, wherein the transitions ensure that the movement within the 3D model appears constant.
